(19) United States
(12) Patent Application Publication
(10) Pub. No.: US 2012/0052396 A1
(43) Pub. Date: Mar. 1, 2012

(54) ALL-SOLID BATTERY

(75) Inventors: Yasushi Tsuchida, Susono-shi (JP); Yukiyoshi Ueno, Gotenba-shi (JP); Shigenori Hama, Susono-shi (JP); Hirofumi Nakamoto, Susono-shi (JP); Hiroshi Nagase, Susono-shi (JP); Masato Kamiya, Susono-shi (JP); Kazunori Takada, Tsukuba-shi (JP)

(73) Assignees: NATIONAL INSTITUTE FOR MATERIALS SCIENCE, Tsukuba-shi, Ibaraki (JP); TOYOTA JIDOSHA KABUSHIKI KAISHA, Toyota-shi, Aichi-ken (JP)

(21) Appl. No.: 13/131,764

(22) PCT Filed: Dec. 1, 2009
(86) PCT No.: PCT/JP2009/007634

§ 371 Date: Jun. 30, 2011

(30) Foreign Application Priority Data
Dec. 2, 2008 (JP) 2008-307276

(51) Int. Cl. H01M 10/02; H01M 4/36; B82Y 30/00

(52) U.S. Cl. 429/304; 977/755

(57) ABSTRACT

An all-solid battery includes: a positive electrode active material layer that includes a positive electrode active material; a negative electrode active material layer that includes a negative electrode active material; and a solid electrolyte layer that is formed between the positive electrode active material layer and the negative electrode active material layer. The positive electrode active material layer or the solid electrolyte layer further includes a solid electrolyte material. A reaction suppressing portion is formed at an interface between the positive electrode active material and the solid electrolyte material. The reaction suppressing portion is a chemical compound that includes a cation portion formed of a metal element and a polyanion portion formed of a central element that forms covalent bonds with a plurality of oxygen elements.

### BACKGROUND OF THE INVENTION

1. Field of the Invention

The invention relates to an all-solid battery that is able to suppress an increase over time in interface resistance between a positive electrode active material and a solid electrolyte material.

2. Description of the Related Art

With a rapid proliferation of information-related equipment and communication equipment, such personal computers, camcorders and cellular phones, in recent years, it becomes important to develop an excellent battery (for example, lithium battery) as a power source of the information-related equipment or the communication equipment. In addition, in fields other than the information-related equipment and the communication-related equipment, for example, in automobile industry, development of lithium batteries, and the like, used for electric vehicles or hybrid vehicles has been proceeding.

Here, existing commercially available lithium batteries employ an organic electrolytic solution that uses a flammable organic solvent. Therefore, it is necessary to install a safety device that suppresses an increase in temperature at the time of a short circuit or improve in terms of a structure or a material for short-circuit prevention. In contrast to this, all-solid batteries that replace a liquid electrolyte with a solid electrolyte do not include a flammable organic solvent in the batteries. For this reason, it is considered that the all-solid batteries contribute to simplification of a safety device and are excellent in manufacturing cost or productivity.

In the field of such all-solid batteries, in the existing art, there is an attempt to improve the performance of an all-solid battery by focusing on the interface between a positive electrode active material and a solid electrolyte material. For example, Narumi Ohta et al., “LiNbO₃-coated LiCoO₂ as cathode material for all solid-state lithium secondary batteries”, Electrochemistry Communications 9 (2007) 1486-1490 describes a material in which the surface of LiCoO₂ (positive electrode active material) is coated with LiNbO₃. This technique attempts to obtain a high-power battery in such a manner that the surface of LiCoO₂ is coated with LiNbO₃ to reduce the interface resistance between LiCoO₂ and the solid electrolyte material. In addition, Japanese Patent Application Publication No. 2008-027581 (JP-A-2008-027581) describes an electrode material for all-solid secondary battery of which the surface is treated with sulfur and/or phosphorus. This attempts to improve ion conducting path by surface treatment. Japanese Patent Application Publication No. 2001-052733 (JP-A-2001-052733) describes a sulfide-based solid battery in which lithium chloride is supported on the surface of a positive electrode active material. This attempts to reduce the interface resistance in such a manner that lithium chloride is supported on the surface of the positive electrode active material.

As described in Narumi Ohta et al., “LiNbO₃-coated LiCoO₂ as cathode material for all solid-state lithium secondary batteries”, Electrochemistry Communications 9 (2007) 1486-1490, when the surface of LiCoO₂ is coated with LiNbO₃, it is possible to reduce the interface resistance between the positive electrode active material and the solid electrolyte material at the initial stage. However, the interface resistance increases over time.

### SUMMARY OF THE INVENTION

The invention provides an all-solid battery that is able to suppress an increase over time in interface resistance between a positive electrode active material and a solid electrolyte material.

An increase over time in the interface resistance is because LiNbO₃ reacts with the positive electrode active material and the solid electrolyte material to produce a reaction product and then the reaction product serves as a resistance layer. This is due to a relatively low electrochemical stability of LiNbO₃. Then, it was found that, when a chemical compound having a polyanion portion that includes covalent bonds is used instead of LiNbO₃, the above chemical compound hardly reacts with the positive electrode active material or the solid electrolyte material. The aspect of the invention is based on the above findings.

That is, a first aspect of the invention provides an all-solid battery. The all-solid battery includes: a positive electrode active material layer that includes a positive electrode active material; a negative electrode active material layer that includes a negative electrode active material; and a solid electrolyte layer that is formed between the positive electrode active material layer and the negative electrode active material layer. The solid electrolyte material forms a resistance layer at an interface between the solid electrolyte material and the positive electrode active material when the solid electrolyte material reacts with the positive electrode active material, and the resistance layer increases resistance of the interface. A reaction suppressing portion is formed at the interface between the positive electrode active material and the solid electrolyte material. The reaction suppressing portion suppresses a reaction between the solid electrolyte material and the positive electrode active material. The reaction suppressing portion is a chemical compound that includes a cation portion formed of a metal element and a polyanion portion formed of a central element that forms covalent bonds with a plurality of oxygen elements.

With the above all-solid battery, the reaction suppressing portion is formed of a chemical compound having a polyanion structure that has a high electrochemical stability. Therefore, it is possible to prevent the reaction suppressing portion from reacting with the positive electrode active material or the solid electrolyte material that forms a resistance layer. This can suppress an increase over time in the interface resistance of the interface between the positive electrode active material and the solid electrolyte material. As a result, it is possible to obtain an all-solid battery having an excellent durability. The polyanion portion of the chemical compound having a polyanion structure includes the central element that forms covalent bonds with the plurality of oxygen elements, so the electrochemical stability increases.

In the all-solid battery according to the above aspect, an electronegativity of the central element of the polyanion portion may be greater than or equal to 1.74. By so doing, it is possible to form further stable covalent bonds.

In the all-solid battery according to the above aspect, the positive electrode active material layer may include the solid electrolyte material. By so doing, it is possible to improve the ion conductivity of the positive electrode active material layer.

In the all-solid battery according to the above aspect, the solid electrolyte layer may include the solid electrolyte material. By so doing, it is possible to obtain an all-solid battery that has an excellent ion conductivity.

In the all-solid battery according to the above aspect, a surface of the positive electrode active material may be coated with the reaction suppressing portion. The positive electrode active material is harder than the solid electrolyte material, so the reaction suppressing portion that coats the positive electrode active material is hard to peel off.

In the all-solid battery according to the above aspect, the cation portion may be Li⁺. By so doing, it is possible to obtain an all-solid battery that is useful in various applications.

In the all-solid battery according to the above aspect, the polyanion portion may be PO₄³⁻ or SiO₄⁴⁻. By so doing, it is possible to effectively suppress an increase over time in the interface resistance.

In the all-solid battery according to the above aspect, the solid electrolyte material may include a bridging chalcogen. The solid electrolyte material that includes a bridging chalcogen has a high ion conductivity, so it is possible to obtain a high-power battery.

In the all-solid battery according to the above aspect, the bridging chalcogen may be a bridging sulfur or a bridging oxygen. By so doing, it is possible to obtain a solid electrolyte material that has an excellent ion conductivity.

In the all-solid battery according to the above aspect, the positive electrode active material may be an oxide-based positive electrode active material. By so doing, it is possible to obtain an all-solid battery having a high energy density.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a view that illustrates an example of a power generating element of an all-solid battery according to an embodiment of the invention;

FIG. 2 is a view that shows a chemical compound having a polyanion structure;

FIG. 3 is a view that shows that bridging sulfur is replaced with bridging oxygen according to a related art;

FIG. 4 is a reference table that shows the electronegativities of elements belonging to group 12 to group 16 in electronegativities (Pauling);

FIG. 5A is a schematic cross-sectional view that illustrates a state where the surface of a positive electrode active material is coated with a reaction suppressing portion;

FIG. 5B is a schematic cross-sectional view that illustrates a state where the surface of a solid electrolyte material is coated with a reaction suppressing portion;

FIG. 5C is a schematic cross-sectional view that illustrates a state where both the surface of a positive electrode active material and the surface of a solid electrolyte material are coated with a reaction suppressing portion;

FIG. 5D is a schematic cross-sectional view that illustrates a state where a positive electrode active material, a solid electrolyte material and a reaction suppressing portion are mixed with one another;

FIG. 6A is a schematic cross-sectional view that illustrates a state where a reaction suppressing portion is formed at an interface between a positive electrode active material layer that includes a positive electrode active material and a solid electrolyte layer that includes a solid electrolyte material that forms a high-resistance layer;

FIG. 6B is a schematic cross-sectional view that illustrates a state where the surface of a positive electrode active material is coated with a reaction suppressing portion;

FIG. 6C is a schematic cross-sectional view that illustrates a state where the surface of a solid electrolyte material that forms a high-resistance layer is coated with a reaction suppressing portion;

FIG. 6D is a schematic cross-sectional view that illustrates a state where both the surface of a positive electrode active material and the surface of a solid electrolyte material that forms a high-resistance layer are coated with a reaction suppressing portion;

FIG. 7 is a graph that shows the results of measurement of the rate of change in interface resistance of an all-solid lithium secondary battery obtained in Example 1 and Comparative example 1;

FIG. 8A is a graph that shows the results of XRD measurement of an evaluation sample of Example 2-1;

FIG. 8B is a graph that shows the results of XRD measurement of an evaluation sample of Example 2-2;

FIG. 9A is a graph that shows the results of XRD measurement of an evaluation sample of Example 3-1;

FIG. 9B is a graph that shows the results of XRD measurement of an evaluation sample of Example 3-2;

FIG. 10A is a graph that shows the results of XRD measurement of an evaluation sample of Comparative example 2-1;

FIG. 10B is a graph that shows the results of XRD measurement of an evaluation sample of Comparative example 2-2;

FIG. 11A is a graph that shows the results of XRD measurement of an evaluation sample of Comparative example 3-1;

FIG. 11B is a graph that shows the results of XRD measurement of an evaluation sample of Comparative example 3-2;

FIG. 12 is a view that illustrates a two-phase pellet prepared in a reference example; and

FIG. 13 is a graph that shows the results of Raman spectroscopy measurement of a two-phase pellet.

### DETAILED DESCRIPTION OF EMBODIMENTS

Hereinafter, an all-solid battery according to an embodiment of the invention will be described in detail.

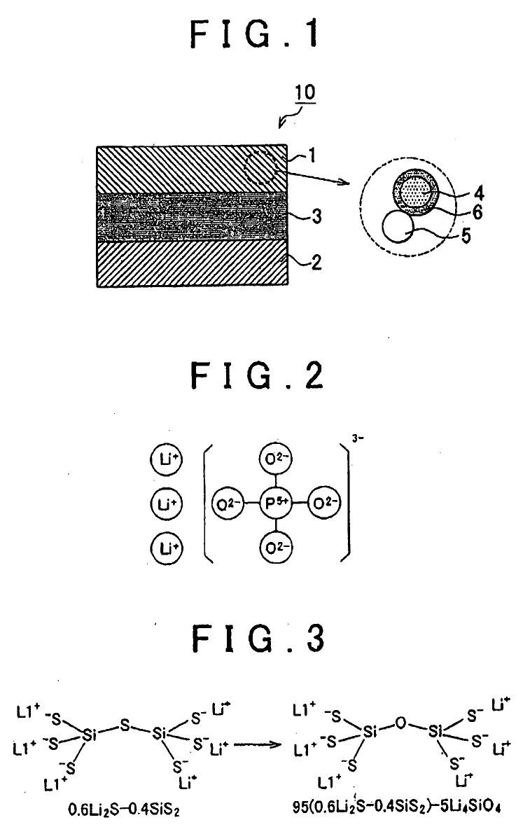

FIG. 1 is a view that illustrates an example of a power generating element 10 of an all-solid battery. The power generating element 10 of the all-solid battery shown in FIG. 1 includes a positive electrode active material layer 1, a negative electrode active material layer 2, and a solid electrolyte layer 3. The positive electrode active material layer 1 includes a positive electrode active material 4. The negative electrode active material layer 2 includes a negative electrode active material. The solid electrolyte layer 3 is formed between the positive electrode active material layer 1 and the negative electrode active material layer 2. The positive electrode active material layer 1 further includes a solid electrolyte material 5 and a reaction suppressing portion 6 in addition to the positive electrode active material 4. When the solid electrolyte material 5 reacts with the positive electrode active material 4, the solid electrolyte material 5 forms a high-resistance layer. The reaction suppressing portion 6 is formed at the interface between the positive electrode active material 4 and the solid electrolyte material 5. In addition, the reaction suppressing portion 6 is a chemical compound having a polyanion structure. The polyanion structure has a cation portion and a polyanion portion. The cation portion is formed of a metallic element that serves as a conducting ion. The polyanion portion is formed of a central element that forms covalent bonds with a plurality of oxygen elements.

As shown in FIG. 1, the surface of the positive electrode active material 4 is coated with the reaction suppressing portion 6. In addition, the reaction suppressing portion 6 is a chemical compound (for example, Li₃PO₄) having a polyanion structure. Here, as shown in FIG. 2, Li₃PO₄ has a cation portion (Li⁺) and a polyanion portion (PO₄³⁻). The cation portion is formed of lithium elements. The polyanion portion is formed of a phosphorus element that forms covalent bonds with a plurality of oxygen elements.

The reaction suppressing portion 6 is a chemical compound having a polyanion structure. The polyanion structure has a high electrochemical stability. Therefore, it is possible to prevent the reaction suppressing portion 6 from reacting with the positive electrode active material 4 or the solid electrolyte material 5. This can suppress an increase over time in interface resistance between the positive electrode active material 4 and the solid electrolyte material 5. As a result, it is possible to obtain an all-solid battery having a high durability. The polyanion portion, which is a chemical compound having a polyanion structure, has a central element that forms covalent bonds with a plurality of oxygen elements. Thus, the polyanion portion has a high electrochemical stability.

Note that the above described JP-A-2008-027581 describes that a sulfide-based glass made from Li₂S, B₂S₃ and Li₃PO₄ is used in surface treatment for a positive electrode material and a negative electrode material (Examples 13 to 15 in JP-A-2008-027581). Li₃PO₄ (chemical compound expressed by LiₐMO_{b}) in these examples and the chemical compound having a polyanion structure according to the embodiment of the invention are similar to each other in chemical composition and are apparently different from each other in function.

Here, Li₃PO₄ (chemical compound expressed by LiₐMO_{b}) in JP-A-2008-027581 is persistently used as an additive agent that improves the lithium ion conductivity of the sulfide-based glass. The reason why ortho oxysalt, such as Li₃PO₄, improves the lithium ion conductivity of the sulfide-based glass is as follows. Addition of ortho oxysalt, such as Li₃PO₄, makes it possible to replace the bridging sulfur of the sulfide-based glass with bridging oxygen. Thus, the bridging oxygen strongly attracts electrons to make it easier to produce lithium ions. Tsutomu Minami et. al, “Recent Progress of glass and glass-ceramics as solid electrolytes for lithium secondary batteries”, 177 (2006) 2715-2720 describes that Li₄SiO₄ (chemical compound expressed by LiₐMO_{b} in JP-A-2008-027581) is added to the sulfide-based glass of 0.6Li₂S-0.4Si₂S to thereby replace bridging sulfur with bridging oxygen as shown in FIG. 3 and then the bridging oxygen strongly attracts electrons, thus improving lithium ion conductivity.

In this way, Li₃PO₄ (chemical compound expressed by LiₐMO_{b}) in JP-A-2008-027581 is an additive agent for introducing bridging oxygen to the sulfide-based glass, and does not maintain a polyanion structure (PO₄³⁻) having a high electrochemical stability. In contrast, Li₃PO₄ (chemical compound having a polyanion structure) according to the embodiment of the invention forms the reaction suppressing portion 6 while maintaining a polyanion structure (PO₄³⁻). In terms of this point, Li₃PO₄ (chemical compound expressed by LiₐMO_{b}) in JP-A-2008-027581 and the chemical compound having a polyanion structure in the embodiment of the invention apparently differ from each other. In addition, Li₃PO₄ (chemical compound expressed by LiₐMO_{b}) in JP-A-2008-027581 is persistently an additive agent. Therefore, Li₃PO₄ is not used alone but necessarily used together with Li₂S, B₂S₃, or the like, that serves as a principal component of the sulfide-based glass. In contrast, Li₃PO₄ (chemical compound having a polyanion structure) in the embodiment of the invention is a principal component of the reaction suppressing portion 6, and greatly differs from Li₃PO₄ of JP-A-2008-027581 in that the chemical compound having a polyanion structure may be used alone. Hereinafter, the power generating element 10 of the all-solid battery according to the embodiment of the invention will be described component by component.

First, the positive electrode active material layer 1 will be described. The positive electrode active material layer 1 at least includes the positive electrode active material 4. Where necessary, the positive electrode active material layer 1 may include at least one of the solid electrolyte material 5 and a conducting material. In this case, the solid electrolyte material 6 included in the positive electrode active material layer 1 may be the solid electrolyte material 5 that reacts with the positive electrode active material 4 to form a high-resistance layer. In addition, when the positive electrode active material layer 1 includes both the positive electrode active material 4 and the solid electrolyte material 5 that forms a high-resistance layer, the reaction suppressing portion 6 made of a chemical compound having a polyanion structure is also formed in the positive electrode active material layer 1.

Next, the positive electrode active material 4 will be described. The positive electrode active material 4 varies depending on the type of conducting ions of the all-solid battery. For example, when the all-solid battery is an all-solid lithium secondary battery, the positive electrode active material 4 occludes or releases lithium ions. In addition, the positive electrode active material 4 reacts with the solid electrolyte material 5 to form a high-resistance layer.

The positive electrode active material 4 is not specifically limited as long as it reacts with the solid electrolyte material 5 to form a high-resistance layer. For example, the positive electrode active material 4 may be an oxide-based positive electrode active material. By using the oxide-based positive electrode active material, the all-solid battery having a high energy density may be obtained. The oxide-based positive electrode active material 4 used for the all-solid lithium battery may be, for example, a general formula LiₓM_{y}O_{z} (where M is a transition metallic element, x=0.02 to 2.2, y=1 to 2 and z=1.4 to 4). In the above general formula, M may be at least one selected from the group consisting of Co, Mn, Ni, V, Fe and Si, and is, more desirably, at least one selected from the group consisting of Co, Ni and Mn. The above oxide-based positive electrode active material may be, specifically, LiCoO₂, LiMnO₂, LiNiO₂, LiVO₂, LiNi_{1/3}Co_{1/3}Mn_{1/3}O₂, LiMn₂O₄, Li(Ni_{0.5}Mn_{1.5})O₄, Li₂FeSiO₄, Li₂MnSiO₄, or the like. In addition, the positive electrode active material 4 other than the above general formula LiₓM_{y}O_{z} may be an olivine positive electrode active material, such as LiFePO₄ and LiMnPO₄.

The shape of the positive electrode active material 4 may be, for example, a particulate shape and, among others, the shape is desirably a spherical shape or an ellipsoidal shape. In addition, when the positive electrode active material 4 has a particulate shape, the mean particle diameter may, for example, range from 0.1 μm to 50 μm. The content of the positive electrode active material 4 in the positive electrode active material layer 1 may, for example, range from 10 percent by weight to 99 percent by weight and, more desirably, range from 20 percent by weight to 90 percent by weight.

The positive electrode active material layer 1 may include the solid electrolyte material 5 that forms a high-resistance layer. By so doing, the ion conductivity of the positive electrode active material layer 1 may be improved. In addition, the solid electrolyte material 5 that forms a high-resistance layer generally reacts with the above described positive electrode active material 4 to form a high-resistance layer. Note that formation of the high-resistance layer may be identified by transmission electron microscope (TEM) or energy dispersive X-ray spectroscopy (EDX).

The solid electrolyte material 5 that forms a high-resistance layer may include a bridging chalcogen. The solid electrolyte material 5 that includes a bridging chalcogen has a high ion conductivity. Thus, it is possible to improve the ion conductivity of the positive electrode active material layer 1, and it is possible to obtain a high-power battery. On the other hand, as will be described in a reference example, in the solid electrolyte material 5 that includes a bridging chalcogen, the bridging chalcogen has a relatively low electrochemical stability. For this reason, the solid electrolyte material 5 more easily reacts with the existing reaction suppressing portion (for example, the reaction suppressing portion made of LiNbO₃) to form a high-resistance layer, so an increase over time in the interface resistance is remarkable. In contrast, the reaction suppressing portion 6 according to the embodiment of the invention has an electrochemical stability higher than that of LiNbO₃. Therefore, the reaction suppressing portion 6 is hard to react with the solid electrolyte material 5 that includes a bridging chalcogen, so it is possible to suppress formation of a high-resistance layer. By so doing, it is possible to improve the ion conductivity while suppressing an increase over time in the interface resistance.

The bridging chalcogen may be bridging sulfur (—S—) or bridging oxygen (—O—) and is, more desirably, bridging sulfur. By so doing, the solid electrolyte material 5 having an excellent ion conductivity may be obtained. The solid electrolyte material 5 that includes bridging sulfur is, for example, Li₇P₃S₁₁, 0.6Li₂S-0.4SiS₂, 0.6Li₂S-0.4GeS₂, or the like. Here, the above Li₇P₃S₁₁ is a solid electrolyte material that has a PS₃—S—PS₃ structure and a PS₄ structure. The PS₃—S—PS₃ structure includes bridging sulfur. In this way, the solid electrolyte material 5 that forms a high-resistance layer may have a PS₃—S—PS₃ structure. By so doing, it is possible to improve the ion conductivity while suppressing an increase over time in the interface resistance. On the other hand, the solid electrolyte material that includes bridging oxygen may be, for example, 95(0.6Li₂S-0.4SiS₂)-5Li₄SiO₄, 95(0.67Li₂S-0.33P₂S₅)-5Li₃PO₄, 95(0.6Li₂S-0.4GeS₂)-5Li₃PO₄, or the like.

In addition, when the solid electrolyte material 5 that forms a high-resistance layer is a material that includes no bridging chalcogen, a specific example of the above material may be Li_{1.3}Al_{0.3}Ti_{1.7}(PO₄)₃, Li_{1.3}Al_{1.3}Ge_{1.7}(PO₄)₃, 0.8Li₂S-0.2P₂S₅, Li_{3.25}Ge_{0.25}P_{0.75}S₄, or the like. Note that the solid electrolyte material 5 may be a sulfide-based solid electrolyte material or an oxide-based solid electrolyte material.

In addition, the shape of the solid electrolyte material 5 may be, for example, a particulate shape and, among others, the shape is desirably a spherical shape or an ellipsoidal shape. In addition, when the solid electrolyte material 5 has a particulate shape, the mean particle diameter may, for example, range from 0.1 μm to 50 μm. The content of the solid electrolyte material 5 in the positive electrode active material layer 1 may, for example, range from 1 percent by weight to 90 percent by weight and, more desirably, ranges from 10 percent by weight to 80 percent by weight.

Next, the reaction suppressing portion 6 will be described. When the positive electrode active material layer 1 includes both the positive electrode active material 4 and the solid electrolyte material 5 that forms a high-resistance layer, generally, the reaction suppressing portion 6 made of a chemical compound having a polyanion structure is also formed in the positive electrode active material layer 1. This is because the reaction suppressing portion 6 needs to be formed at the interface between the positive electrode active material 4 and the solid electrolyte material 5 that forms a high-resistance layer. The reaction suppressing portion 6 has the function of suppressing reaction between the positive electrode active material 4 and the solid electrolyte material 5 that forms a high-resistance layer. The reaction occurs while the battery is being used. The chemical compound that has a polyanion structure and that constitutes the reaction suppressing portion 6 has an electrochemical stability higher than that of the existing niobium oxide (for example, LiNbO₃). Thus, it is possible to suppress an increase over time in the interface resistance.

First, the chemical compound that has a polyanion structure and that constitutes the reaction suppressing portion 6 will be described. The chemical compound having a polyanion structure generally includes a cation portion and a polyanion portion. The cation portion is formed of a metallic element that serves as a conducting ion. The polyanion portion is formed of a central element that forms covalent bonds with a plurality of oxygen elements.

The metal element used for the cation portion varies depending on the type of the all-solid battery. The metal element is, for example, alkali metal, such as Li and Na, or alkali earth metal, such as Mg and Ca, and, among others, the metal element is desirably Li. That is, in the embodiment of the invention, the cation portion is desirably Li⁺. By so doing, it is possible to obtain an all-solid lithium battery that is useful in various applications.

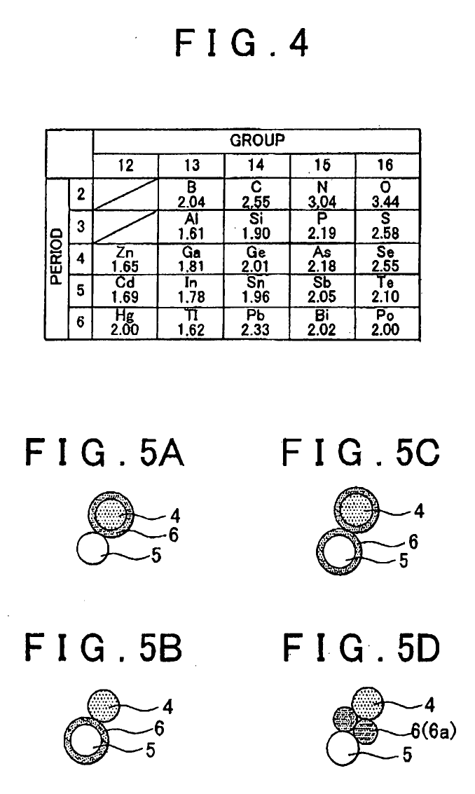

On the other hand, the polyanion portion is formed of a central element that forms covalent bonds with a plurality of oxygen elements. In the polyanion portion, the central element and the oxygen elements form covalent bonds with each other, so it is possible to increase the electrochemical stability. A difference between the electronegativity of the central element and the electronegativity of each oxygen element may be 1.7 or below. By so doing, it is possible to form stable covalent bonds. Here, considering that the electronegativity of the oxygen element is 3.44 in electronegativities (Pauling), the electronegativity of the central element of the polyanion portion may be greater than or equal to 1.74. Furthermore, the electronegativity of the central element may be greater than or equal to 1.8 and may be, more desirably, greater than or equal to 1.9. By so doing, further stable covalent bonds are formed. For reference, FIG. 4 shows the electronegativities of elements belonging to group 12 to group 16 in electronegativities (Pauling). Although not shown in the following table, the electronegativity of Nb that is used for the existing niobium oxide (for example, LiNbO₃) is 1.60.

The polyanion portion according to the embodiment of the invention is not specifically limited as long as it is formed of a central element that forms covalent bonds with a plurality of oxygen elements. For example, the polyanion portion may be PO₄³⁻, SiO₄⁴⁻, GeO₄⁴⁻, BO₃³⁻ or the like.

In addition, the reaction suppressing portion 6 may be formed of a composite compound of the above described chemical compounds having a polyanion structure. The above composite compound is a selected combination of the above described chemical compounds having a polyanion structure. The composite compound may be, for example, Li₃PO₄—Li₄SiO₄, Li₃BO₃—Li₄SiO₄, Li₃PO₄—Li₄GeO₄, or the like. The above composite compound may be, for example, formed by PVD (for example, pulse laser deposition (PLD), sputtering) using a target. The target is manufactured to include a plurality of chemical compounds having a polyanion structure. In addition, the composite compound may be formed by liquid phase method, such as sol-gel process, or mechanical milling, such as ball milling.

In addition, the reaction suppressing portion 6 may be an amorphous chemical compound having a polyanion structure. By using an amorphous chemical compound having a polyanion structure, it is possible to form the thin, uniform reaction suppressing portion 6, thus making it possible to increase surface coverage. By so doing, the ion conductivity may be improved, and an increase over time in the interface resistance may be further suppressed. In addition, the amorphous chemical compound having a polyanion structure has a high ion conductivity, so it is possible to obtain a high-power battery. Note that the fact that the chemical compound having a polyanion structure is amorphous may be identified through X-ray diffraction (XRD) measurement.

The content of the chemical compound having a polyanion structure in the positive electrode active material layer 1 may, for example, range from 0.1 percent by weight to 20 percent by weight and, more desirably, ranges from 0.5 percent by weight to 10 percent by weight.

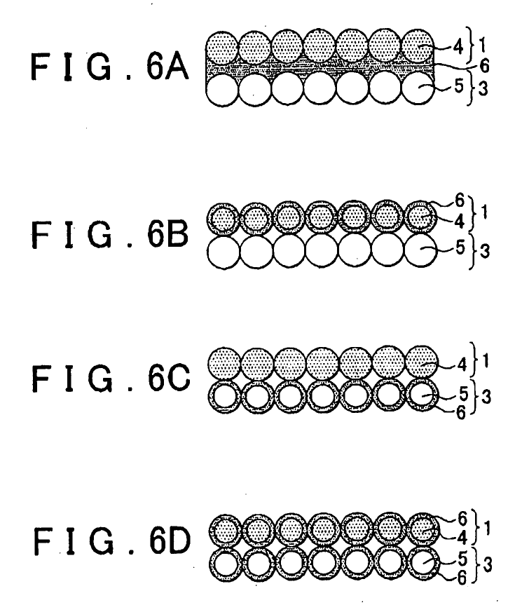

Next, the form of the reaction suppressing portion 6 in the positive electrode active material layer 1 will be described. When the positive electrode active material layer 1 includes the solid electrolyte material 5 that forms a high-resistance layer, the reaction suppressing portion 6 made of a chemical compound having a polyanion structure is generally formed in the positive electrode active material layer 1. The form of the reaction suppressing portion 6 in this case may be, for example, a form in which the surface of the positive electrode active material 4 is coated with the reaction suppressing portion 6 (FIG. 5A), a form in which the surface of the solid electrolyte material 5 is coated with the reaction suppressing portion 6 (FIG. 5B), a form in which both the surface of the positive electrode active material 4 and the surface of the solid electrolyte material 5 are coated with the reaction suppressing portion 6 (FIG. 5C), or the like. Among others, the reaction suppressing portion 6 is desirably formed to coat the surface of the positive electrode active material 4. The positive electrode active material 4 is harder than the solid electrolyte material 5 that forms a high-resistance layer, so the coating reaction suppressing portion 6 is hard to peel off.

Note that the positive electrode active material 4, the solid electrolyte material 5 and a chemical compound having a polyanion structure, which serves as the reaction suppressing portion 6, may be simply mixed with one another. In this case, as shown in FIG. 5D, a chemical compound 6a having a polyanion structure is arranged between the positive electrode active material 4 and the solid electrolyte material 5 to make it possible to form the reaction suppressing portion 6. In this case, the effect of suppressing an increase over time in the interface resistance is slightly poor; however, the manufacturing process for the positive electrode active material layer 1 may be simplified.

In addition, the reaction suppressing portion 6 that coats the positive electrode active material 4 or the solid electrolyte material 5 desirably has a thickness to an extent such that these materials do not react with each other. For example, the thickness of the reaction suppressing portion 6 may range from 1 nm to 500 nm and, more desirably ranges from 2 nm to 100 nm. If the thickness of the reaction suppressing portion 6 is too small, there is a possibility that the positive electrode active material 4 reacts with the solid electrolyte material 5. If the thickness of the reaction suppressing portion 6 is too large, there is a possibility that the ion conductivity decreases. In addition, the reaction suppressing portion 6 desirably coats a surface area of the positive electrode active material 4, or the like, as much as possible, and more desirably coats all the surface of the positive electrode active material 4, or the like. By so doing, it is possible to effectively suppress an increase over time in the interface resistance.

A method of forming the reaction suppressing portion 6 may be appropriately selected on the basis of the above described form of the reaction suppressing portion 6. For example, when the reaction suppressing portion 6 that coats the positive electrode active material 4 is formed, a method of forming the reaction suppressing portion 6 is, specifically, rolling fluidized coating (sol-gel process), mechanofusion, CVD, PVD, or the like.

The positive electrode active material layer 1 may further include a conducting material. By adding the conducting material, it is possible to improve the conductivity of the positive electrode active material layer 1. The conducting material is, for example, acetylene black, Ketjen black, carbon fiber, or the like. In addition, the content of the conducting material in the positive electrode active material layer 1 is not specifically limited. The content of the conducting material may, for example, range from 0.1 percent by weight to 20 percent by weight. In addition, the thickness of the positive electrode active material layer 1 varies depending on the type of the all-solid battery. The thickness of the positive electrode active material layer may, for example, range from 1 μm to 100 μm.

Next, the solid electrolyte layer 3 will be described. The solid electrolyte layer 3 at least includes the solid electrolyte material 5. As described above, when the positive electrode active material layer 1 includes the solid electrolyte material 5 that forms a high-resistance layer, the solid electrolyte material 5 used for the solid electrolyte layer 3 is not specifically limited; instead, it may be a solid electrolyte material that forms a high-resistance layer or may be a solid electrolyte material other than that. On the other hand, when the positive electrode active material layer 1 includes no solid electrolyte material 5 that forms a high-resistance layer, generally, the solid electrolyte layer 3 includes the solid electrolyte material 5 that forms a high-resistance layer. Specifically, both the positive electrode active material layer 1 and the solid electrolyte layer 3 desirably include the solid electrolyte material 5 that forms a high-resistance layer. By so doing, it is possible to improve the ion conductivity while suppressing an increase over time in the interface resistance. In addition, the solid electrolyte material 5 used for the solid electrolyte layer 3 may be only a solid electrolyte material that forms a high-resistance layer.

Note that the solid electrolyte material 5 that forms a high-resistance layer is similar to the above described content. In addition, a solid electrolyte material other than the solid electrolyte material 5 that forms a high-resistance layer may be a material similar to that of the solid electrolyte material used for a typical all-solid battery.

When the solid electrolyte layer 3 includes the solid electrolyte material 5 that forms a high-resistance layer, the reaction suppressing portion 6 that includes the above described chemical compound having a polyanion structure is generally formed in the positive electrode active material layer 1, in the solid electrolyte layer 3 or at the interface between the positive electrode active material layer 1 and the solid electrolyte layer 3. The form of the reaction suppressing portion 6 in this case includes a form in which the reaction suppressing portion 6 is formed at the interface between the positive electrode active material layer 1 that includes the positive electrode active material 4 and the solid electrolyte layer 3 that includes the solid electrolyte material 5 that forms a high-resistance layer (FIG. 6A), a form in which the surface of the positive electrode active material 4 is coated with the reaction suppressing portion 6 (FIG. 6B), a form in which the surface of the solid electrolyte material 5 that forms a high-resistance layer is coated with the reaction suppressing portion 6 (FIG. 6C), a form in which both the surface of the positive electrode active material 4 and the surface of the solid electrolyte material 5 that forms a high-resistance layer are coated with the reaction suppressing portion 6 (FIG. 6D), and the like. Among others, the reaction suppressing portion 6 desirably coats the surface of the positive electrode active material 4. The positive electrode active material 4 is harder than the solid electrolyte material 5 that forms a high-resistance layer, so the reaction suppressing portion 6 that coats the surface of the positive electrode active material 4 is hard to peel off.

The thickness of the solid electrolyte layer 3 may, for example, range from 0.1 μm to 1000 μm and, among others, may range from 0.1 μm to 300 μm.

Next, the negative electrode active material layer 2 will be described. The negative electrode material layer 2 at least includes a negative electrode active material, and, where necessary, may include at least one of the solid electrolyte material 5 and a conducting material. The negative electrode active material varies depending on the type of the conducting ion of the all-solid battery, and is, for example, a metal active material or a carbon active material. The metal active material may be, for example, In, Al, Si, Sn, or the like. On the other hand, the carbon active material may be, for example, mesocarbon microbead (MCMB), highly oriented graphite (HOPG), hard carbon, soft carbon, or the like. Note that the solid electrolyte material 5 and the conducting material used for the negative electrode active material layer 2 are similar to those in the case of the above described positive electrode active material layer 1. In addition, the thickness of the negative electrode active material layer 2, for example, ranges from 1 μm to 200 μm.

The all-solid battery at least includes the above described positive electrode active material layer 1, the solid electrolyte layer 3 and the negative electrode active material layer 2. Furthermore, generally, the all-solid battery includes a positive electrode current collector and a negative electrode current collector. The positive electrode current collector collects current from the positive electrode active material layer 1. The negative electrode current collector collects current from the negative electrode active material. The material of the positive electrode current collector is, for example, SUS, aluminum, nickel, iron, titanium, carbon, or the like, and, among others, may be SUS. On the other hand, the material of the negative electrode current collector is, for example, SUS, copper, nickel, carbon, or the like, and, among others, is desirably SUS. In addition, the thickness, shape, and the like, of each of the positive electrode current collector and the negative electrode current collector are desirably selected appropriately on the basis of application, or the like, of the all-solid battery. In addition, a battery case of the all-solid battery may be a typical battery case for an all-solid battery. The battery case may be, for example, a SUS battery case, or the like. In addition, the all-solid battery may be the one in which the power generating element 10 is formed inside an insulating ring.

In the embodiment of the invention, the reaction suppressing portion 6 made of a chemical compound having a polyanion structure that has a high electrochemical stability is used, so the type of the conducting ion is not specifically limited. The all-solid battery may be an all-solid lithium battery, an all-solid sodium battery, an all-solid magnesium battery, an all-solid calcium battery, or the like, and, among others, may be an all-solid lithium battery or an all-solid sodium battery, and, particularly, is desirably an all-solid lithium battery. In addition, the all-solid battery according to the embodiment of the invention may be a primary battery or a secondary battery. The secondary battery may be repeatedly charged or discharged, and is useful in, for example, an in-vehicle battery. The all-solid battery may, for example, have a coin shape, a laminated shape, a cylindrical shape, a square shape, or the like.

In addition, a method of manufacturing an all-solid battery is not specifically limited as long as the above described all-solid battery may be obtained. The method of manufacturing an all-solid battery may be a method similar to a typical method of manufacturing an all-solid battery. An example of the method of manufacturing an all-solid battery includes a step of preparing the power generating element 10 by sequentially pressing a material that constitutes the positive electrode active material layer 1, a material that constitutes the solid electrolyte layer 3 and a material that constitutes the negative electrode active material layer 2; a step of accommodating the power generating element 10 inside a battery case; and a step of crimping the battery case.

Note that the aspect of the invention is not limited to the above embodiment. The above embodiment is only illustrative; the technical scope of the invention encompasses any embodiments as long as the embodiments have substantially similar configuration to those of the technical ideas recited in the appended claims of the invention and the embodiments are able to suppress an increase over time in the interface resistance while improving the ion conductivity as in the case of the aspect of the invention.

Specific examples according to the invention will be described below.

First, Example 1 will be described. In preparation of a positive electrode having the reaction suppressing portion 6, the positive electrode active material layer 1 made of LiCoO₂ having a thickness of 200 nm was formed on a Pt substrate by PLD. Subsequently, commercially available Li₃PO₄ and Li₄SiO₄ were mixed at the mole ratio of 1 to 1 and pressed to prepare a pellet. Using the pellet as a target, the reaction suppressing portion 6 made of Li₃PO₄—Li₄SiO₄ having a thickness of 5 nm to 20 nm was formed on the positive electrode active material 4 by PLD. By so doing, the positive electrode having the reaction suppressing portion 6 on its surface was obtained.

After that, in preparation of an all-solid lithium secondary battery, first, Li₇P₃S₁₁ (solid electrolyte material having bridging sulfur) was obtained through a method similar to the method described in JP-A-2005-228570. Note that Li₇P₃S₁₁ is the solid electrolyte material 5 having a PS₃—S—PS₃ structure and a PS₄ structure. Then, a pressing machine was used to prepare the above described power generating element 10 as shown in FIG. 1. The positive electrode having the positive electrode active material layer 1 was the above described positive electrode. A material that constitutes the negative electrode active material layer 2 was In foil and metal Li piece. A material that constitutes the solid electrolyte layer 3 was Li₇P₃S₁₁. The power generating element 10 was used to obtain the all-solid lithium secondary battery.

Next, Comparative example 1 will be described. Except that monocrystal LiNbO₃ was used as a target for forming the reaction suppressing portion 6, an all-solid lithium secondary battery was obtained in the method similar to that of Example 1.

Next, evaluation of Example 1 and Comparative example 1 will be described. For the all-solid lithium secondary batteries obtained in Example 1 and Comparative example 1, the interface resistance was measured and the interface was observed by TEM.

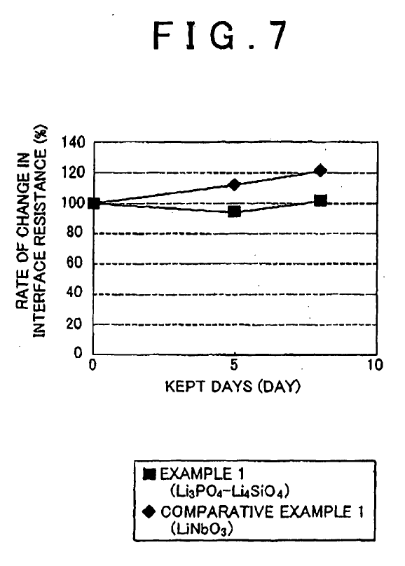

Measurement of the interface resistance will be described. First, the all-solid lithium secondary batteries were charged. Charging was conducted at a constant voltage of 3.34 V for 12 hours. After charging, impedance measurement was carried out to obtain the interface resistance between the positive electrode active material layer 1 and the solid electrolyte layer 3. Impedance measurement was carried out at a voltage amplitude of 10 mV, a measurement frequency of 1 MHz to 0.1 Hz and a temperature of 25° C. After that, the all-solid lithium secondary batteries were kept for 8 days at 60° C., and, similarly, the interface resistance between the positive electrode active material layer 1 and the solid electrolyte layer 3 was measured. A rate of change in interface resistance was calculated from the interface resistance value after initial charging (interface resistance value at the zeroth day), the interface resistance value at the fifth day and the interface resistance at the eighth day. The results were shown in FIG. 7.

As shown in FIG. 7, the results of the rate of change in the interface resistance of the all-solid lithium secondary battery of Example 1 were better than the results of the rate of change in the interface resistance of the all-solid lithium secondary battery of Comparative example 1. This is because Li₃PO₄—Li₄SiO₄ used in Example 1 has an electrochemical stability higher than LiNbO₃ used in Comparative example 1 and has a higher function as the reaction suppressing portion 6. Note that the interface resistance value of Example 1 at the eight day was 9 kΩ.

Next, observation of the interface by TEM will be described. After the above charge and discharge was completed, the all-solid lithium secondary batteries were disassembled, and then the interface between the positive electrode active material 4 and the solid electrolyte material 5 that includes a bridging chalcogen was observed by transmission electron microscope (TEM). As a result, in the all-solid lithium secondary battery obtained in Comparative example 1, formation of the high-resistance layer was identified in the reaction suppressing portion 6 (LiNbO₃) that is present at the interface between the positive electrode active material 4 (LiCoO₂) and the solid electrolyte material 5 (Li₇P₃S₁₁) that includes a bridging chalcogen. In contract, in the all-solid lithium secondary battery obtained in Example 1, no formation of a high-resistance layer was identified in the reaction suppressing portion 6 (Li₃PO₄—Li₄SiO₄). By so doing, it was determined that Li₃PO₄—Li₄SiO₄ was stable against LiCoO₂ and Li₇P₃S₁₁.

Next, Example 2 will be described. In Example 2, reactivity over time between a chemical compound (Li₄SiO₄) having a polyanion structure and the positive electrode active material 4 (LiCoO₂) and reactivity over time between a chemical compound (Li₄SiO₄) having a polyanion structure and the solid electrolyte material 5 (Li₇P₃S₁₁) having a bridging chalcogen were evaluated. Here, the interface states of these materials were evaluated by a technique that mechanical energy and thermal energy are applied to these materials.

First, Li₄SiO₄ and LiCoO₂ at a volume ratio of 1 to 1 were put into a pot, and were subjected to ball milling at a rotational speed of 150 rpm for 20 hours. Subsequently, the obtained powder was subjected to heat treatment at 120° C. in Ar atmosphere for two weeks to obtain an evaluation sample (Example 2-1). In addition, except that Li₇P₃S₁₁ was used instead of LiCoO₂, a technique similar to that of Example 2-1 was used to obtain an evaluation sample (Example 2-2).

Next, Example 3 will be described. In Example 3, except that Li₃PO₄ was used instead of Li₄SiO₄, a technique similar to those of Example 2-1 and Example 2-2 was used to obtain evaluation samples (Example 3-1, Example 3-2).

Next, Comparative example 2 will be described. In Comparative example 2, except that LiNbO₃ was used instead of Li₄SiO₄, a technique similar to those of Example 2-1 and Example 2-2 was used to obtain evaluation samples (Comparative example 2-1, Comparative example 2-2).

Next, Comparative example 3 will be described. In Comparative example 3, reactivity between the positive electrode active material 4 (LiCoO₂) and the solid electrolyte material 5 (Li₇P₃S₁₁) that includes a bridging chalcogen was evaluated. Specifically, except that the volume ratio of LiCoO₂ to Li₇P₃S₁₁ was set at 1 to 1, a technique similar to that of Example 2-1 was used to obtain an evaluation sample (Comparative example 3-1). In addition, LiCoO₂ and Li₇P₃S₁₁ were mixed at the same ratio as that of Comparative example 3-1 to obtain an evaluation sample (Comparative example 3-2). Comparative example 3-2 was not subjected to ball milling and heat treatment.

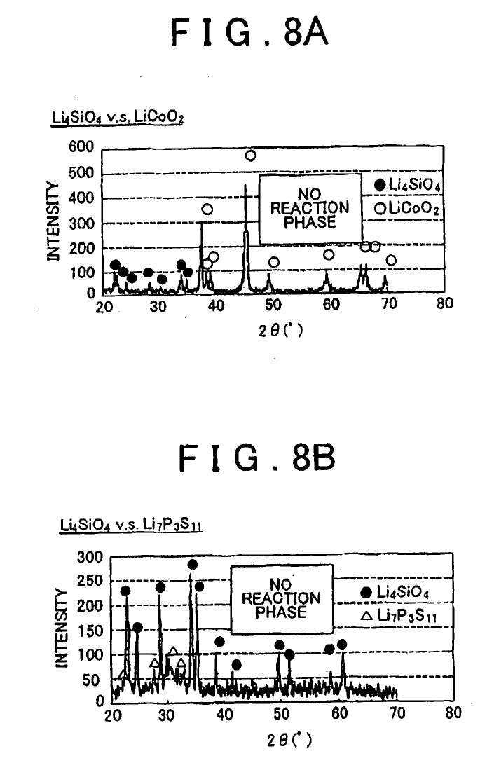

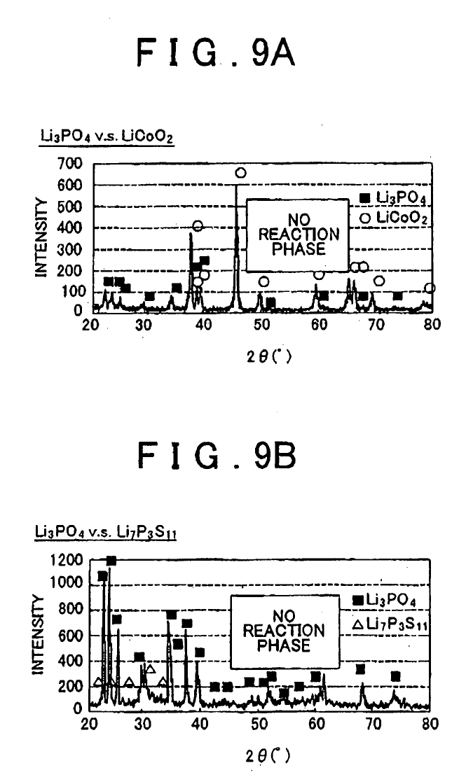

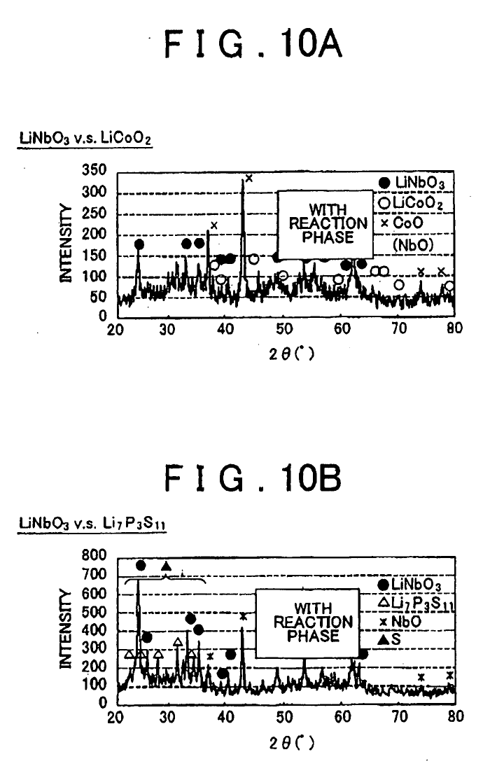

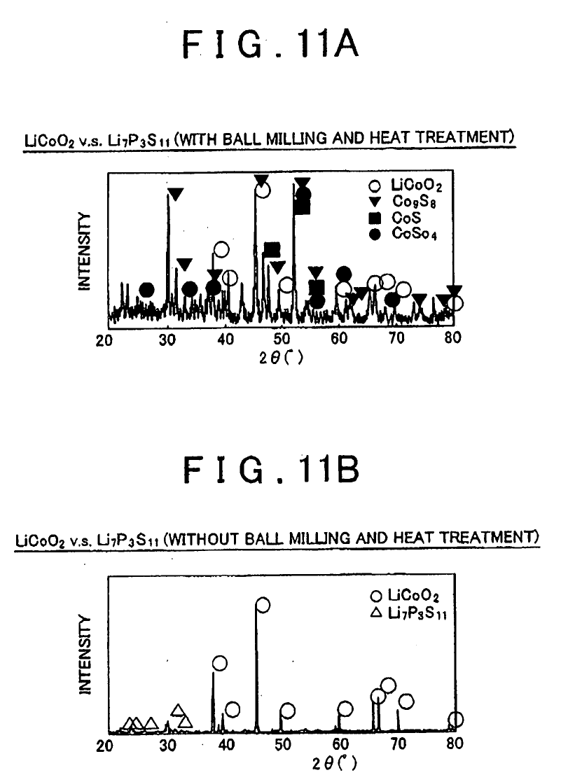

Next, second evaluation will be described. The evaluation samples obtained in Examples 2 and 3 and Comparative examples 2 and 3 were used and subjected to X-ray diffraction (XRD) measurement. The results are shown in FIG. 8A to FIG. 11B. As shown in FIG. 8A that shows the XRD measurement results of Example 2-1 and in FIG. 8B that shows the XRD measurement results of Example 2-2, it is determined that Li₄SiO₄ does not form a reaction phase against either LiCoO₂ or Li₇P₃S₁₁. Similarly, as shown in FIG. 9A that shows the XRD measurement results of Example 3-1 and FIG. 9B that shows the XRD measurement results of Example 3-2, it is determined that Li₃PO₄ does not form a reaction phase against either LiCoO₂ or Li₇P₃S₁₁. This is because, the chemical compound having a polyanion structure has covalent bonds between Si or P and O and has a high electrochemical stability. In contrast, as shown in FIG. 10A that shows the XRD measurement results of Comparative example 2-1 and FIG. 10B that shows the XRD measurement results of Comparative example 2-2, it is determined that LiNbO₃ reacts with LiCoO₂ to produce CoO(NbO) and LiNbO₃ reacts with Li₇P₃S₁₁ to produce NbO or S. In view of the above results, it is conceivable that these reaction products function as a high-resistance layer that increases the interface resistance. In addition, as shown in FIG. 11A that shows the XRD measurement results of Comparative example 3-1 and FIG. 11B that shows the XRD measurement results of Comparative example 3-2, it is determined that CO₉S₈, CoS, CoSO₄, and the like, are produced as LiCoO₂ reacts with Li₇P₃S₁₁. In view of the above results as well, it is conceivable that these reaction products function as a high-resistance layer that increases the interface resistance.

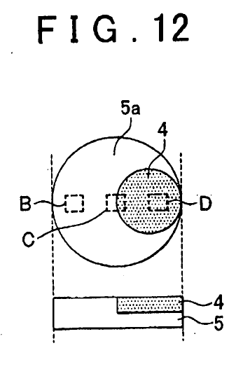

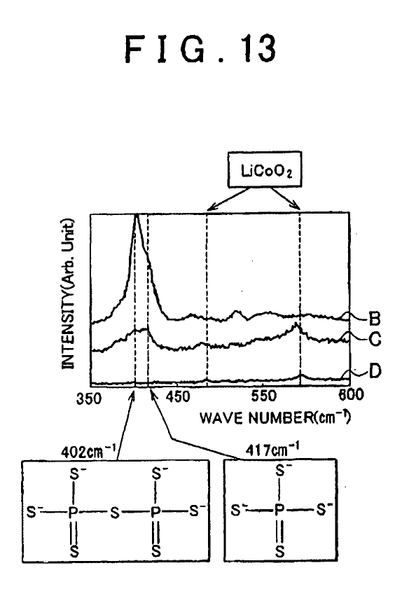

Next, the reference example will be described. In the reference example, the state of the interface between the positive electrode active material 4 and the solid electrolyte material 5 that includes a bridging chalcogen was observed by Raman spectroscopy. First, LiCoO₂ was provided as the positive electrode active material, and Li₇P₃S₁₁ that was synthesized in Example 1 was provided as the solid electrolyte material that includes a bridging chalcogen. Then, as shown in FIG. 12, two-phase pellet in which the positive electrode active material 4 was embedded in part of a solid electrolyte material 5a that includes a bridging chalcogen was prepared. After that, Raman spectroscopy measurement was performed in a region B that is the region of the solid electrolyte material 5a that includes a bridging chalcogen, a region C that is the region of the interface between the solid electrolyte material 5a that includes a bridging chalcogen and the positive electrode active material 4 and in a region D that is the region of the positive electrode active material 4. The results are shown in FIG. 13.

In FIG. 13, the peak of 402 cm⁻¹ is a peak of PS₃—S—PS₃ structure, and the peak of 417 cm⁻¹ is a peak of PS₄ structure. In the region B, the large peaks were detected at 402 cm⁻¹ and 417 cm⁻¹, whereas, in the region C, these peaks both were small. Particularly, a reduction in peak at 402 cm⁻¹ (peak of PS₃—S—PS₃ structure) was remarkable. In view of these facts, it is determined that the PS₃—S—PS₃ structure that greatly contributes to lithium ion conduction fails more easily. In addition, it was suggested that, by using the above solid electrolyte material, the all-solid battery is able to suppress an increase over time in the interface resistance while improving the ion conductivity.

1-14. (canceled)

15. An all-solid battery comprising:
a positive electrode active material layer that includes a positive electrode active material;
a negative electrode active material layer that includes a negative electrode active material; and
a solid electrolyte layer that includes a solid electrolyte material and is formed between the positive electrode active material layer and the negative electrode active material layer, wherein
the solid electrolyte material forms a resistance layer at an interface between the solid electrolyte material and the positive electrode active material when the solid electrolyte material reacts with the positive electrode active material, and the resistance layer increases resistance of the interface,
a reaction suppressing portion is formed at the interface between the positive electrode active material and the solid electrolyte material,
the reaction suppressing portion suppresses a reaction between the solid electrolyte material and the positive electrode active material, and
the reaction suppressing portion is a chemical compound that includes a cation portion formed of a metal element and a polyanion portion formed of a central element that forms covalent bonds with a plurality of oxygen elements
the reaction suppressing portion is the chemical compound selected from a group consisting of Li₃PO₄, Li₄SiO₄, Li₃BO₃, and Li₄GeO₄, and
the solid electrolyte material is an inorganic solid electrolyte material.

16. The all-solid battery according to claim 15, wherein
the chemical compound of the reaction suppressing portion having a polyanion structure in the positive electrode active material layer is ranged from 0.1 percent by weight to 20 percent by weight.

17. The all-solid battery according to claim 15, wherein
an electronegativity of the central element of the polyanion portion is greater than or equal to 1.74.

18. The all-solid battery according to claim 15, wherein
the positive electrode active material layer includes the solid electrolyte material.

19. The all-solid battery according to claim 15, wherein
a surface of the positive electrode active material is coated with the reaction suppressing portion.

20. The all-solid battery according to claim 15, wherein
the cation portion is Li⁺.

21. The all-solid battery according to claim 15, wherein
the polyanion portion is PO₄³⁻ or SiO₄⁴⁻.

22. The all-solid battery according to claim 15, wherein
the solid electrolyte material includes a bridging chalcogen.

23. The all-solid battery according to claim 22, wherein
the bridging chalcogen is a bridging sulfur or a bridging oxygen.

24. The all-solid battery according to claim 15, wherein
the positive electrode active material is an oxide-based positive electrode active material.

25. The all-solid battery according to claim 15, wherein
the reaction suppressing portion is formed in a state where a polyanion structure of the polyanion portion is maintained.

26. The all-solid battery according to claim 15, wherein
the chemical compound is an amorphous chemical compound.

27. The all-solid battery according to claim 15, wherein
the positive electrode active material, the solid electrolyte material and the chemical compound are mixed with one another to form the reaction suppressing portion at the interface between the positive electrode active material and the solid electrolyte material.

28. The all-solid battery according to claim 15, wherein
a thickness of the reaction suppressing portion ranges from 1 nm to 500 nm.
